(19) United States
(12) Patent Application Publication
(10) Pub. No.: US 2004/0081789 A1
(43) Pub. Date: Apr. 29, 2004

(54) Cool roof asphalt waterproofing sheet and joint sealing structure thereof

(76) Inventor: Choong-Yup Kim, Dan-ji (KR)

Correspondence Address: Welsh & Katz, Ltd., THOMAS R. VIGIL, 22nd Floor, 120 South Riverside Plaza, Chicago, IL, 60606, US

(21) Appl. No.: 10/280,997

(22) Filed: Oct. 25, 2002

(51) Int. Cl. B32B 3/00; B32B 9/00; B32B 33/00

(52) U.S. Cl. 428/40.3; 442/235; 442/236; 442/278; 442/394; 428/41.8; 428/57

(57) ABSTRACT

The asphalt waterproofing sheet and a joint sealing structure thereof can improve the fire resisting capacity of an asphalt waterproofing layer by the laminating of an aluminum film and a polymer layer on an asphalt sheet thereby to prevent the overheat of a roof structure by reflecting the incident sunlight. Here, the asphalt sheet may allow a release paper to be attached to the bottom surface thereof. The joint sealing structure according to the present invention includes two cool roof asphalt waterproofing sheets spaced apart from each other by a predetermined gap, a polymer filling material formed by applying a liquid polymer material to the gap between the adjacent waterproofing sheets and hardening the liquid polymer material, and an aluminum tape longitudinally mounted inside the polymer filling material in such a manner as to cover the gap between the waterproofing sheets, wherein a fire resisting capacity is maintained over the entire waterproofing area including a joint portion between the waterproofing sheets.

### BACKGROUND OF THE INVENTION

1. Field of the Invention.

The present invention relates to an improved asphalt waterproofing sheet and a joint sealing structure thereof, and more particularly, to a cool roof asphalt waterproofing sheet and a joint sealing structure thereof which can improve the fire resisting capacity of an asphalt waterproofing layer by laminating an aluminum film and a polymer layer on an asphalt sheet and prevent a roof structure from being overheated by reflecting the incident sunlight.

2. Description of the Prior Art.

In general, on the rooftop of a building is applied various kinds of waterproofing methods to prevent water leakage due to precipitation or the like. An asphalt waterproofing method, and a water-soluble or oil-soluble fluid-applied waterproofing method are widely used.

The fluid-applied waterproofing method forms a waterproofing layer by repeatedly applying a liquid type waterproofing agent to the surface of a structure, and has an advantage in that it can form a waterproofing layer without joint lines and can be easily applied to a narrow portion. The fluid-applied waterproofing method, however, has a drawback in that it tends to suffer an undulation due to a water vapor pressure generated by humidity contained in a concrete substrate structure, and let the waterproofing layer broken when a crack occurs in the structure, resulting in water leakage.

Recently, the asphalt waterproofing method which forms a waterproofing layer by using asphalt as a main waterproofing material is widely used to prevent the waterproofing layer from being damaged due to a crack formed on the substrate structure as previously said. The asphalt waterproofing method is divided into one in which asphalt is heated and melted and applied to a portion to be applied in many folds to form a waterproofing layer, and the other in which asphalt is rubberized in the form of sheet in a factory, and then the asphalt formed at the bottom surface of the sheet is heated by means of an LPG burner(torch burner) in a construction site to be melted and spreadingly attached on the rooftop in the melted state.

In the above methods, the latter, asphalt waterproofing sheet method, is simple in execution and can reduce a construction period, such that it has recently become one of the most widely used methods.

By the way, the latter has a problem in that when the waterproofing sheet is exposed to the sunlight for a long time, a crack occurs on the surface of the sheet, leading to reduction in the useful life of the sheet. That is, ultraviolet rays contained in the sunlight accelerate the polymerization of hydrocarbon molecules constituting the asphalt waterproofing sheet and thus the surface of the asphalt waterproofing sheet becomes hardened, resulting in a crack on the asphalt and water leakage of the rooftop.

Further, since the asphalt is very weak against heat, if a fire breaks out, the asphalt would be readily melted and produce a hazardous gas. Therefore, the asphalt sheet requires an appropriate protective layer in order to enhance the fire resisting capacity.

To solve the above problems, there have been made attempts to form a protective mortar layer or a crushed aggregate layer on the asphalt sheet.

Particularly, there has been developed a method in which an asphalt sheet formed at the lower portion of the asphalt waterproofing sheet is protected by placing an aluminum foil at the upper portion of the asphalt waterproofing sheet, which is disclosed in U.S. Pat. No. 5,096,759. In the U.S. patent, when the aluminum foil is attached to the asphalt layer, the aluminum foil reflects the sunlight and intercepts the ultraviolet rays, thereby increasing the durable period of the asphalt waterproofing sheet. Furthermore, aluminum is greatly strong against heat so that when the aluminum foil is laminated on the asphalt layer, the fire resisting capacity of the asphalt waterproofing sheet can be improved.

The conventional aluminum-faced asphalt waterproofing sheet, however, has a disadvantage in that it can be easily oxidized during its reaction to oxygen in the air. Once the aluminum foil is oxidized, it becomes rusty on the surface thereof, whereby the fire resisting capacity thereof deteriorates, and the aluminum foil loses the surface gloss thereof, leading to decrease in reflectivity of the sunlight.

In the meantime, with the recent development in industry and improvement of a living standard, while the amount of power demanded is rapidly increasing, the amount of power supplied is limited. Thus, energy saving has become an important issue. In particular, the peak power demand is recorded in summer. This is because the use of such electric appliances as air conditioners requiring great power consumption is increased and a power consumed as a cooling energy is accordingly increased. Therefore, there have been suggested a variety of methods for reducing the cooling energy, which include one using a “cool roof” system. The cool roof system refers to a system in which a light colored material having a high reflectivity of the sunlight is employed on the rooftop of a building, instead of a conventional deep colored material, so as to prevent solar heat from being transferred through a lower roof structure and protect the temperature of the whole building from rising.

Methods adopting the cool roof system include a method of applying a white polymer layer to the surface of a roof and a method of adhering a roof shingle. The former is more widely used in general. The aforesaid aluminum-faced asphalt sheet is not suitable for the “cool roof” system. This is because aluminum reflects the sunlight to a certain extent after its installation so that a system using the aluminum can function as the “cool roof” system, but as time goes by, the surface of the aluminum is oxidized and the reflectivity of the sunlight deteriorates. Consequently, the aluminum cannot maintain an enough reflectivity to enable the system to function as the cool roof system.

Meanwhile, in conventional methods for installing the asphalt waterproofing sheet including the aforesaid aluminum-faced asphalt waterproofing sheet, a primer is first applied to the surface of the roof and thereafter the asphalt waterproofing sheet is installed. Over the edge portion of the installed asphalt waterproofing sheet, is laid the edge portion of another asphalt waterproofing sheet. A joint portion between the edge portions is melted by means of a torch and sealed together, so as for water not to permeate thereinto. Such a method of heating and melting the joint portion, however, has a problem in that if overheat is applied, the sheets may be damaged, whereas if the joint portion is not sufficiently heated, it is not uniformly sealed, thereby causing water leakage.

To solve the above problem, a joint sealing structure, so-called an “I shape sealing structure”, has been developed as shown in Korean Publication No. 2001-95666. The I shape sealing structure which was also invented by the present inventor comprises asphalt sheets spaced apart from each other by a predetermined gap on a roof deck, a melted asphalt filled into the gap, a reinforced fabric mounted on the melted asphalt, and another melted asphalt applied on the reinforced fabric. In the construction, the joint portion of the sheets is covered by the melted asphalt such that a perfect waterproofing can be achieved.

If the I shape sealing structure is applied to the aforementioned aluminum-faced asphalt waterproofing sheet, however, the fire resisting capacity of the joint portion between the sheets cannot be ensured. In other words, the sheets have a fire resisting capacity by virtue of the aluminum foil attached to the surface thereof, while the joint portion between the sheets consists only of asphalt and thus it doesn't have a sufficient fire resisting capacity. In consequence, the fire resisting capacity of the entire waterproofing system cannot be ensured. As a result, to apply the I shape sealing structure to the aluminum-faced asphalt waterproofing sheet, the joint portion should be properly treated to have a fire resisting capacity.

### BRIEF SUMMARY OF THE INVENTION

Accordingly, the present invention is directed to a cool roof asphalt waterproofing sheet and a joint sealing structure thereof that substantially obviate one or more problems due to limitations and disadvantages of the related art.

An object of the present invention is to provide an asphalt waterproofing sheet which can maintain a fire resisting capacity of an aluminum-faced waterproofing sheet longer and has a reflectivity of the sunlight high enough to be suitable for a cool roof system.

Another object of the present invention is to provide an asphalt waterproofing sheet which is subjected to a cool roof coating in a factory in advance and then delivered to a construction site, thereby performing a sheet waterproofing process and a cool roof coating process at a stroke.

A further object of the present invention is to provide a joint sealing structure of cool roof asphalt waterproofing sheets through which a fire resisting capacity can be maintained over the entire waterproofing area including a joint portion between sheets when a conventional I joint method is applied to a cool roof asphalt waterproofing system according to the present invention.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings. To achieve these objects and other advantages and in accordance with the purpose of the invention, as embodied and broadly described herein, there is provided a cool roof asphalt waterproofing sheet comprising: a fibrous sheet layer, an asphalt sheet laminated on the top surface of the fibrous sheet layer, an aluminum film laminated on the top surface of the asphalt sheet, and a polymer layer applied to the top surface of the aluminum film, wherein the polymer layer is processed with a light color, thereby reflecting the sunlight and preventing the lower layers from being overheated.

Initially, the asphalt sheet is manufactured in a factory in the form of sheet by using a rubberized asphalt as a main material. The asphalt sheet is impervious and serves to prevent humidity permeating from the above from being impregnated into the lower layer.

The fibrous sheet layer is formed beneath the asphalt sheet. The fibrous sheet layer acts to reinforce the stiffness of the waterproofing sheet according to the present invention, and serves to promote a waterproofing effect since when the aforementioned I shape sealing structure is applied to the joint portion of waterproofing sheets according to the present invention, a liquid polymer material filled from the above randomly sticks to the fibrous sheet layer and accordingly the sealing between the waterproofing sheet and the liquid polymer material is more strengthened. It is possible that the fibrous sheet layer is not formed. In this case, a release paper is attached to the bottom surface of the asphalt sheet and separated from the asphalt sheet during construction.

The aluminum film is laminated on the top surface of the asphalt sheet. The aluminum film is in the form of relatively thinner sheet. A conventional aluminum-faced asphalt sheet has a general function to protect the asphalt sheet formed therebeneath from the ultraviolet rays of the sunlight. However, the waterproofing sheet of the present invention has an essential objective of having a fire resisting capacity. A reinforced fabric may be further attached beneath the aluminum film to increase the area in contact with the asphalt sheet and thus enhance an adhesive strength. Another reinforced fabric may be further attached to the top surface of the aluminum film to enhance an adhesive force between the liquid cool-coat polymer material and the aluminum film. It is most preferable that a fiberglass woven fabric is used as the reinforced fabric.

The polymer layer is formed on the aluminum film. The polymer layer is formed through the steps of applying a liquid polymer material and hardening the same. Here, the polymer material is selected from the group consisting of acrylic, epoxy, polyurea and polyurethane. The polymer layer becomes the uppermost layer of the waterproofing sheet according to the present invention, and is processed with a light color including white color so as to reflect the incident sunlight and prevent the temperature of the lower layers below the polymer layer and a roof structure from rising. Moreover, the polymer layer blocks the aluminum film from contacting the external air so that the aluminum film can be prevented from being oxidized and the waterproofing sheet of the present invention can maintain the fire resisting capacity longer.

A joint sealing structure of waterproofing sheets according to the present invention will be explained hereinafter.

To apply the waterproofing sheet, there may be used a conventional overlapping structure in which the waterproofing sheets are overlapped and a joint portion between the sheets is hot-melted by a torch or the like to be sealed. When applied to aluminum-faced asphalt sheets, the overlapping structure is advantageous in that the adjacent waterproofing sheets are overlapped and accordingly the fire resisting capacity of the overall waterproofing area can be maintained. The overlapping structure, however, is disadvantageous in that the waterproofing function of the joint portion between the adjacent waterproofing sheets cannot be ensured, as explained above. Accordingly the I shape sealing structure that is an improved joint sealing structure over the conventional overlapping structure may be used. The I shape sealing structure, however, has a disadvantage in that the fire resisting capacity can be maintained in the waterproofing sheets but cannot be maintained in the joint portion between the waterproofing sheets. Therefore, in applying the conventional I shape sealing structure to the cool roof asphalt waterproofing sheet, the present inventor suggests a new joint sealing structure of asphalt waterproofing sheets capable of maintaining the fire resisting capacity over the overall waterproofing area including the joint portion between the sheets.

According to the present invention, a joint sealing structure of two adjacent asphalt waterproofing sheets includes two cool roof asphalt waterproofing sheets, edges of which are spaced apart from each other by a predetermined gap, a polymer filling material filled into the gap by applying a liquid polymer material to a joint portion between the two cool roof asphalt waterproofing sheets, and protruding beyond the region adjacent to the gap in the top surface of the first and second asphalt sheets, and an aluminum tape mounted inside the polymer filling material in such a manner as to longitudinally cover the gap. In contrast to the conventional overlapping sealing structure, the two waterproofing sheets of the present invention are spaced apart from each other by the predetermined gap. A liquid polymer material having a waterproofing function, such as polyurethane, polyurea, or a melted asphalt, is filled into the joint portion between the two spaced waterproofing sheets and then hardened in the joint portion, thereby achieving continuous waterproofing features. A sufficient amount of polymer material is used such that it protrudes beyond the region adjacent to the gap in the top surface of the waterproofing sheets and completely covers the gap.

The aluminum tape is mounted inside the polymer filling material which is formed by filing the liquid polymer material into the gap and curing the same. The aluminum tape is longitudinally mounted in such a manner to cover the gap, leading to a complete cover of the gap. The aluminum tape permits the joint portion between the waterproofing sheets to have a fire resisting capacity. With the help of the aluminum tape mounted in the joint portion, the fire resisting capacity can be maintained over the entire waterproofing area including the joint portion.

It is to be understood that both the foregoing general description and the following detailed description of the present invention are exemplary and explanatory and are intended to provide further explanation of the invention as claimed.

### BRIEF DESCRIPTION OF THE SEVERAL VIEWS OF THE DRAWINGS

The above and other objects, features and advantages of the present invention will be apparent from the following detailed description of the preferred embodiments of the invention in conjunction with the accompanying drawings, in which:

FIG. 1 is a perspective view of the first embodiment showing the various layers, not in proportion.

FIG. 2 is a enlarged cross-sectional view taken along the line A-A of FIG. 1, not in proportion.

FIG. 3 is a perspective view of the second embodiment showing the various layers, not in proportion.

FIG. 4 is an enlarged cross-sectional view taken along the line B-B of FIG. 3, not in proportion.

FIG. 4 is an enlarged cross-sectional view showing the joint sealing structure of the waterproofing sheets according to the present invention, not in proportion.

FIG. 6 is a perspective view showing the application of the joint sealing structure of the waterproofing sheets according to the present invention.

### DETAILED DESCRIPTION OF THE INVENTION

Reference will now be made in detail to the preferred embodiments of the present invention, examples of which are illustrated in the accompanying drawings.

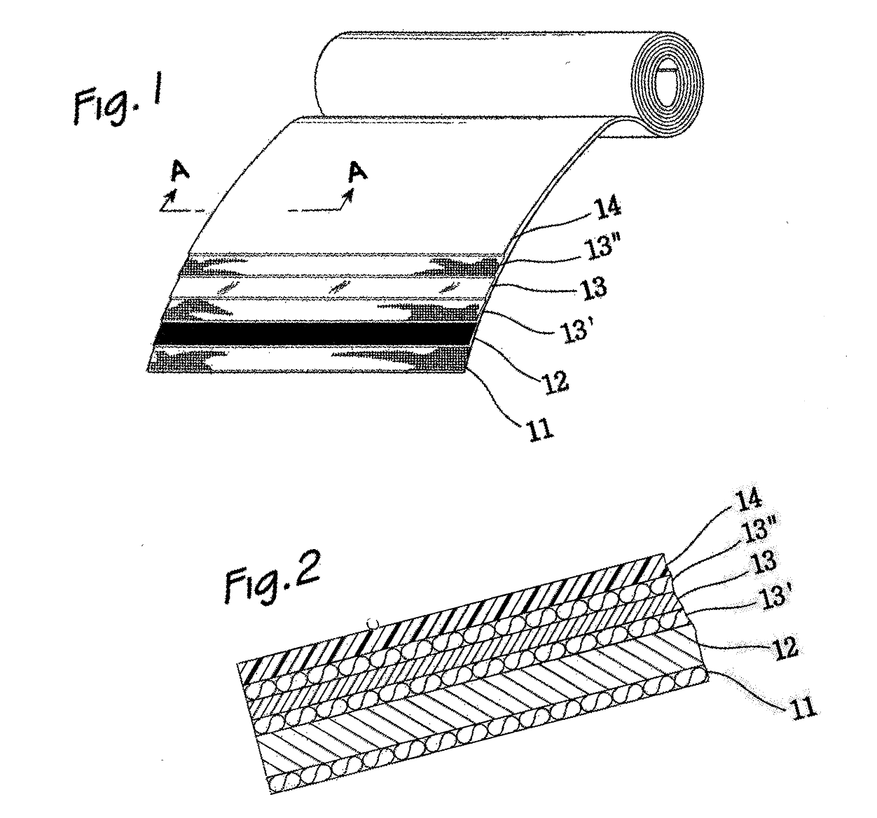

FIGS. 1 and 2 illustrate a cool roof asphalt waterproofing sheet comprising six layers according to a first preferred embodiment of the present invention. The cool roof asphalt waterproofing sheet will be explained in due order from the lowermost layer as follows.

The first layer is a fibrous sheet layer 11 forming the lowermost layer of the, waterproofing sheet. The fibrous sheet layer 11 functions as a reinforced material for improving the strength of the waterproofing sheet. The material of the fibrous sheet layer can be selected from the group consisting of a fiberglass, a synthetic non-woven fabric, a synthetic fiberglass, and a synthetic woven fabric. The fibrous sheet layer includes a great many fibers. When then I shape sealing structure is applied to a joint portion of waterproofing sheets according to the present invention as described hereinbelow, a liquid polymer material permeates into the fibers and randomly sticks to the fibers, thereby more improving the waterproofing function of the joint portion. Here, it is most preferable that the fibrous sheet layer is a polyester non-woven fabric.

An asphalt sheet 12 is laminated on the top surface of the fibrous sheet layer 11. The asphalt sheet has a thickness that can vary, preferably in the range of 1 mm to 5 mm, most preferably in the range of 1.5 mm to 3 mm.

An aluminum film 13 is laminated on the top surface of the asphalt sheet 12. A relatively thinner aluminum film having a thickness of 0.01 mm to 0.1 mm can be used as the aluminum film according to the present invention. In case that the aluminum film is too thin, the waterproofing sheet may not have a sufficient fire resisting capacity and the waterproofing sheet may be readily damaged in the manufacturing process thereof. In case that the aluminum film is too thick, on the other hand, the fire resisting capacity can be superior but the manufacturing costs are increased. Thus, preferably the aluminum film has a thickness of about 0.02 mm.

The aluminum film and the asphalt sheet can be bonded together by hot-melting method or by means of an adhesive. To improve an adhesive force by increasing the area in contact with the asphalt sheet, a fabric 13′ may be further attached beneath the aluminum film. The fabric can be bonded to the aluminum film by means of a very thin adhesive film. Here, the fabric is preferably a fiberglass woven fabric. The aluminum sheet to which the fiberglass woven fabric is attached is commercially available. Further, a fabric 13″ may be attached on the top surface of the aluminum sheet in the same manner as explained in the above, whereby a liquid polymer material applied to the upper side of the aluminum sheet can be more firmly attached to the aluminum sheet. A polymer layer 14 is formed on the top surface of the aluminum film 13. The polymer layer is formed through the steps of applying a liquid polymer material on the upper side of the aluminum film and curing the liquid polymer material. The polymer material is preferably selected from the group consisting of acrylic, epoxy, polyurea and polyurethane, most preferably acrylic. Furthermore, the polymer material is desirably subjected to a fire-retarding treatment. The polymer layer 14 becomes the uppermost layer of the waterproofing sheet 10 of the present invention, and functions to reflect the incident sunlight and prevent the temperature of the lower layers of the waterproofing sheet 10 and a roof structure from rising due to the sunlight. Therefore, the polymer layer 14 is of a light color having a high reflectivity of the sunlight, preferably white color.

The polymer layer 14 is preferably manufactured in a factory in advance in the course of manufacturing the waterproofing sheet according to the present invention. Since the polymer layer 14 is formed in the factory in advance before being delivered to a construction site, a cratfsman can perform both a waterproofing process and a cool roof coating process at a stroke by just installing the waterproofing sheet of the present invention in the construction site.

Meanwhile, the polymer layer is not necessarily be manufactured in the factory in advance but may be formed by applying the liquid polymer material in the construction site. In the latter case, a conventional waterproofing sheet provided with an aluminum foil on the top surface thereof is spreadingly attached on the roof structure and the liquid polymer material is applied to the top surface of the waterproofing sheet.

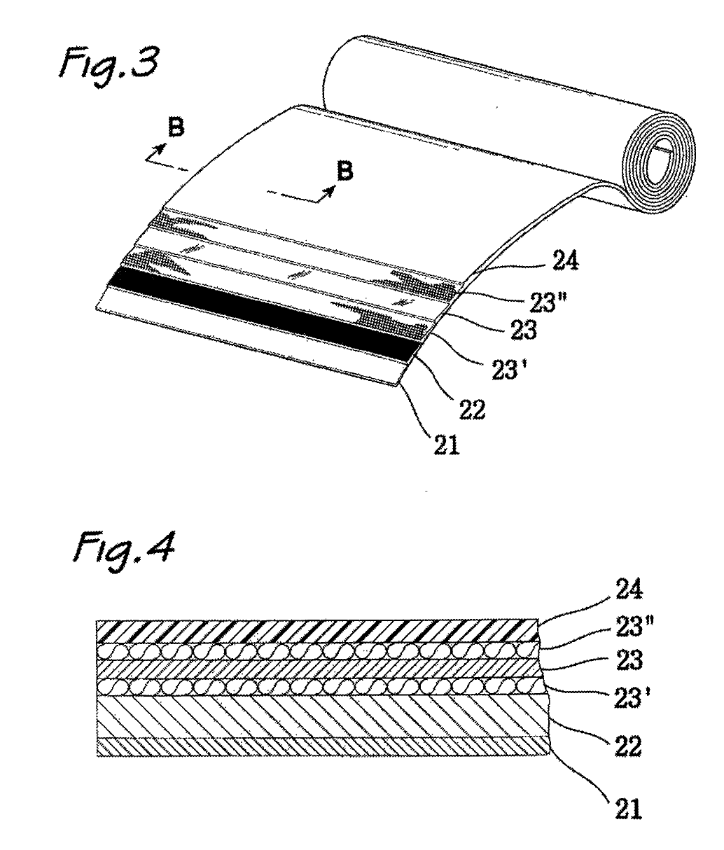

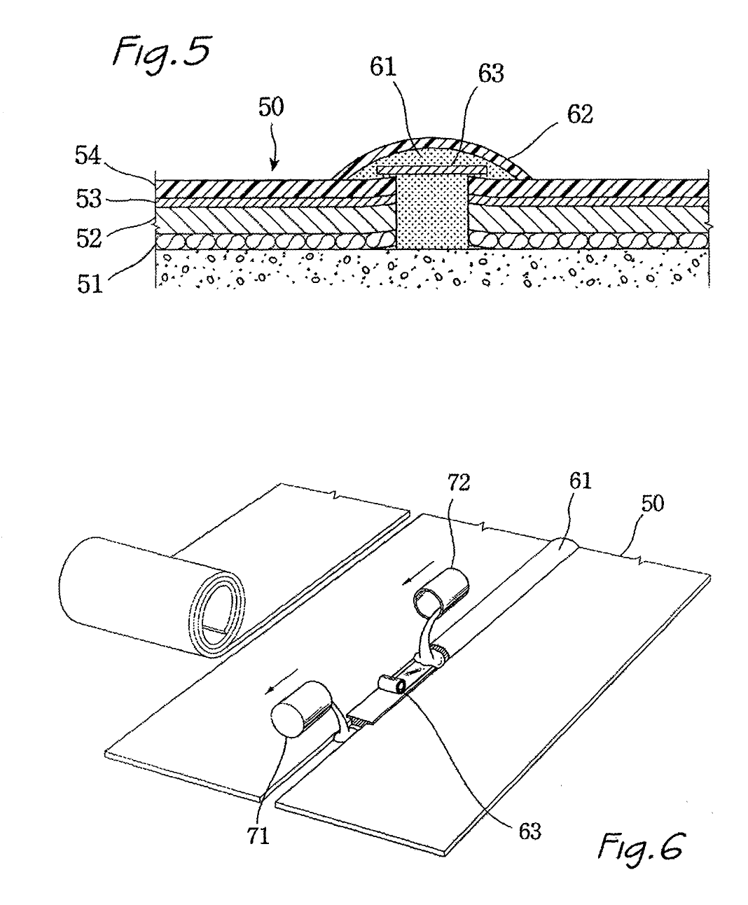

FIGS. 3 and 4 illustrate a waterproofing sheet according to a second preferred embodiment of the asphalt sheet according to the present invention. Referring to FIGS. 3 and 4, a release paper 21 is detachably attached to the asphalt sheet, instead of the fibrous sheet layer 11 of the first preferred embodiment. The waterproofing sheet is manufactured in the form of roll such that the release paper 21 prevents respective layers of the sheet from being adhered to each other. The release paper should be removed before construction.

FIG. 5 illustrates a joint sealing structure of cool roof asphalt waterproofing sheets according to the present invention.

Referring to FIG. 5, the joint sealing structure of the waterproofing sheets according to the present invention includes two adjacent cool roof asphalt waterproofing sheets 50, edges of which are spaced apart from each other by a predetermined gap, a polymer filling material 61 filled into the gap between the two waterproofing sheets by applying a liquid polymer material to the upper side of a joint portion of the two adjacent waterproofing sheets, and protruding beyond the region adjacent to the gap in the top surface of the two asphalt sheets, and an aluminum tape 63 longitudinally mounted inside the polymer filling material 61 in such a manner as to cover the gap. Furthermore, each of the cool roof asphalt waterproofing sheets is formed by laminating a fibrous sheet layer 51, an asphalt sheet 52, an aluminum film 53, and a cool coat polymer layer 54 in due order. The aluminum tape 63 permits a fabric to be attached to at least one of its upper and bottom surfaces. It is preferable that the aluminum tape 63 is firmly placed in the inside of the polymer filling material 61 and the fabric is a fiberglass woven fabric.

The fibrous sheet layer 51 is optionally installable and thus is not necessarily be installed. The polymer material used as the polymer filling material 61 has a waterproofing function, and is preferably selected from the group consisting of polyurethane, polyurea, and asphalt. In particular, since polyurethane and polyurea can be used in a liquid state at ordinary temperature, a heating process which is required upon using asphalt is not required, thereby making an cratfsman feeling simple and convenient.

The polymer material used as the polymer filling material 61 is processed to have a light color like the polymer layer 54 formed at the upper portion of the waterproofing sheet such that the entire waterproofing area including the joint portion as well as the waterproofing sheets can become suitable for the cool coat roof system. Moreover, on the top surface of the polymer filling material 61 can be carried out the same coating as performed in the polymer layer 54 formed at the upper portion of the waterproofing sheet 50.

Referring to FIG. 6, a method for forming the joint sealing structure of the waterproofing sheets according to the present invention will be described hereinbelow.

Initially, the adjacent waterproofing sheets 50 are spreadingly attached on the roof surface in such a manner as to be spaced apart from each other by a predetermined gap. Here, the gap between the adjacent waterproofing sheets 50 is preferably in the range of 0.7 to 1.5 cm, most preferably 1.0 cm. A liquid waterproofing material 71, such as polyurethane, is applied to the upper side of the joint portion between the adjacent waterproofing sheets so as to cover the gap between the two adjacent waterproofing sheets. Here, the liquid waterproofing material 71 should be applied in the sufficient amount to completely cover the gap between the sheets 50 and somewhat cover the regions adjacent to the gap in the top surface of the sheets 50. The aluminum tape 63 is mounted on the upper portion of the joint portion which is filled with the waterproofing material. Here, the width of the aluminum tape has a value greater than the gap between the waterproofing sheets so that the entire waterproofing area can be covered by the aluminum-materialized layer. In the event that the gap between the waterproofing sheets is 1 cm, the width of the aluminum tape is preferably 2.54 cm(1 inch). A liquid waterproofing material 72 of the same material as the waterproofing material filled into the gap between the sheets is applied to the top surface of the aluminum tape so as to completely cover the aluminum tape. A polymer material having the same material and color as the polymer layer of a light color formed on the upper portion of the waterproofing sheets 50 is applied to the top surface of the polymer filling material 61, so that the entire waterproofing area including the joint portion exhibits a function as a cool roof system.

The above-described embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

I claim:

1. A cool roof asphalt waterproofing sheet comprising:
a fibrous sheet layer;
an asphalt sheet laminated on the top surface of the fibrous sheet layer; an aluminum film laminated on the top surface of the asphalt sheet; and
a polymer layer laminated on the top surface of the aluminum film, wherein the polymer layer is processed with a light color, thereby reflecting the sunlight and preventing the temperature of the lower layers below the polymer layer from rising.

2. The cool roof asphalt waterproofing sheet of claim 1, wherein the material of the polymer layer is selected from the group consisting of acrylic, epoxy, polyurea and polyurethane.

3. The cool roof asphalt waterproofing sheet of claim 1, wherein the material of the fibrous sheet layer is a synthetic non-woven fabric or a synthetic woven fabric.

4. The cool roof asphalt waterproofing sheet of claim 1, wherein the aluminum film has a reinforced fabric formed on at least one of the upper and bottom surfaces thereof.

5. The cool roof asphalt waterproofing sheet of claim 4, wherein the reinforced fabric is a fiberglass woven fabric.

6. A cool roof asphalt waterproofing sheet comprising:
an asphalt sheet;
a release paper on the bottom surface of the asphalt sheet; an aluminum film laminated on the top surface of the asphalt sheet; and
a polymer layer laminated on the top surface of the aluminum film, wherein the polymer layer is processed with a light color, thereby reflecting the sunlight and preventing the temperature of the lower layers below the polymer layer from rising.

7. The cool roof asphalt waterproofing sheet of claim 6, wherein the material of the polymer layer is selected from the group consisting of acrylic, epoxy, polyurea and polyurethane.

8. The cool roof asphalt waterproofing sheet of claim 6, wherein the aluminum film has a reinforced fabric formed on at least one of the upper and bottom surfaces thereof.

9. The cool roof asphalt waterproofing sheet of claim 6, wherein the reinforced fabric is a fiberglass woven fabric.

10. A cool roof asphalt waterproofing structure comprising:
a roof structure;
an asphalt sheet laminated on the top surface of the roof structure; an aluminum film laminated on the top surface of the asphalt sheet; and
a polymer layer laminated on the top surface of the aluminum film, wherein the polymer layer is processed with a light color, thereby reflecting the sunlight and preventing the temperature of the lower layers below the polymer layer from rising.

11. The cool roof asphalt waterproofing structure of claim 10, wherein the material of the polymer layer is selected from the group consisting of acrylic, epoxy, polyurea and polyurethane.

12. The cool roof asphalt waterproofing structure of claim 10, wherein the aluminum film has a reinforced fabric formed on at least one of the upper and bottom surfaces thereof.

13. The cool roof asphalt waterproofing structure of claim 10, wherein the reinforced fabric is a fiberglass woven fabric.

14. A joint sealing structure for two adjacent cool roof asphalt waterproofing sheets, comprising:
first and second cool roof asphalt waterproofing sheets, edges of which are spaced apart from each other by a predetermined gap;
a polymer filling material filled into the gap by applying a liquid polymer material to a joint portion between the first and second asphalt waterproofing sheets, and protruding beyond the region adjacent to the gap in the top surface of the first and second asphalt sheets; and
an aluminum tape mounted inside the polymer filling material in such a manner as to longitudinally cover the gap, wherein each of the first and second cool roof asphalt waterproofing sheets includes an asphalt sheet, an aluminum film laminated on the top surface of the asphalt sheet, and a polymer layer of a light color laminated on the top surface of the aluminum film.

15. The joint sealing structure of claim 14, wherein the asphalt sheet has a fibrous sheet layer formed therebeneath.

16. The joint sealing structure of claim 15, wherein the material of the fibrous sheet layer is a synthetic non-woven fabric or a synthetic woven fabric.

17. The joint sealing structure of claim 14, wherein the aluminum film has a fiberglass woven fabric formed on at least one of the upper and bottom surfaces thereof.

18. The joint sealing structure of claim 14, wherein the aluminum tape has a fiberglass woven fabric formed on at least one of the upper and bottom surfaces thereof.

19. The joint sealing structure of claim 14, wherein the material of the polymer filling material is selected from the group consisting of acrylic, epoxy, polyurea and polyurethane.

20. The joint sealing structure of claim 14, wherein the polymer filling material is processed with a light color, thereby reflecting the sunlight to prevent the temperature of the underlying layers from rising.
